(19) United States
(12) Patent Application Publication
(10) Pub. No.: US 2003/0074819 A1
(43) Pub. Date: Apr. 24, 2003

(54) Combination cheering aid and cushion with pocket for hand

(76) Inventor: William Corona, Los Angeles, CA (US)

Correspondence Address: LIU & LIU LLP, Suite 1100, 811 West 7th Street, Los Angeles, CA, 90017, US

(21) Appl. No.: 10/060,612

(22) Filed: Oct. 19, 2001

(51) Int. Cl. G09F 21/02

(52) U.S. Cl. 40/586

(57) ABSTRACT

A combination cheering aid and cushion comprising a body with a front face, a back face, a top edge, and a bottom edge. The combination cheering aid and cushion has a handle that is formed by a recess in the body, which may also be a hole through the front and back face. The handle is in shape of the letter “D.” The body includes a saw-tooth corrugation along the top edge that contributes to the shape or outline of a fence. A slot opening along the bottom face defines a pocket, which is sized to receive a user's hand while the user waves the body during cheering use. The pocket may be sized to receive other objects. The body has insignia on the front face, which may include supportive expressions for use at sporting events, a team logo or color, or sponsor advertisements.

### BACKGROUND OF THE INVENTION

1. Field of the Invention

This invention relates generally to the field of novelty items for use at sporting events, and more particularly to hand-held signs that serve the purpose of a portable seat cushion.

2. Description of Related Art

Various hand-held signs have been used at sporting events to depict the supported individual or team, or supportive expressions. They are often decorated with a suitable logo or slogan and team colors. Some hand-held sign designs have been altered to serve additional purposes, such as stadium seat cushions. For example, U.S. Pat. No. 4,441,271 to Hutchinson describes a combination portable seat cushion and pennant, which includes two cushions to use as pennants and noisemakers. Also, U.S. Pat. No. 5,572,758 to Merritt describes a combination seat cushion and cheering aid with a handle. The user can wave the cushion, extending overhead, by gripping the handle. Another invention for a combination pennant is found in U.S. Pat. No. 4,037,340 to Owensmith, which describes a scarf with hand pockets at each end so that the user can hold the scarf above his head in an extended manner to use as a pennant having words or phrases displayed thereon.

Foam Fingers is a widely commercialized novelty device made of foam, shaped in the form of a hand with a pointed upright finger, for example, to represent “No. 1.” They are designed with a pocket for the hand. “Foam Fingers” and the like have traditionally been made with team colors or logos for use by spectators at sporting events.

U.S. Pat. No. 4,486,975 to Harreld et al. describes an inflatable novelty device in the shape of a hand representing “No. 1” or “V for Victory” with a non-inflatable hand pocket cavity. These are intended to be extensions or enlargements of a waving hand of a person cheering at a sports event. However, there is limited space for an insignia displaying a slogan visible from afar.

U.S. Pat. No. 6,108,817 to Kostelac describes a noisemaker and hand sign that is made of a hand-shaped foam rubber body with a front panel and a rear panel. The front panel has a covering that can be affixed with team logos, colors, slogans or the like. The rear panel contains five digit slits in a pattern such that the spectator can press his or her fingers into the slits to wear the novelty hand sign. The novelty hand sign also has a hand strap connected to a hole that is in one of the comers of the foam body. Because this design is rather complicated, difficult and uncomfortable to use, it has never been successfully commercialized.

The inventor of the present invention developed a novel cheering aid comprising a foam body with a saw-tooth configuration and with a handle in the shape of an open “D” symbolically representing the term “Defense.” The user waves the sign by holding the handle or the edge of the foam body.

It is desirable to provide an improved hand sign that is easy to use and large enough to display more insignia.

### SUMMARY OF THE INVENTION

A combination cheering aid and cushion with a body that has a front face, a back face, a top edge, and a bottom edge. The combination cheering aid and cushion has a handle that is formed by a recess in the body, which may also be a hole through the front face and back face.

The handle of the combination cheering aid and cushion is in shape of the letter “D.” The body includes a saw-tooth corrugation along the top edge that contributes to the shape or outline of a fence.

A slot opening along the bottom face defines a pocket, which is sized to receive a user's hand while the user waves the body during cheering use. The pocket may be sized to receive other objects.

The body has insignia on the front face, which may include supportive expressions for use at sporting events, a team logo or color, or sponsor advertisements.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a front perspective view of a cushion showing the placement of an individual's hand according to one embodiment of the present invention.

FIG. 2 is a front view of the cushion in FIG. 1 according to one embodiment of the present invention.

FIG. 3 is a back view of the cushion in FIG. 1.

FIG. 4 is a top view of the cushion in FIG. 1.

FIG. 5 is a bottom view of the cushion in FIG. 1 with a slot.

FIG. 6 is a left side view of the cushion in FIG. 1.

FIG. 7 is a right side view of the cushion in FIG. 1.

FIG. 8 is a front view of the cushion in FIG. 1 with insignia.

FIG. 9 is a front perspective view of the cushion in FIG. 1 showing the placement of a post according to another embodiment of the present invention.

### DETAILED DESCRIPTION OF THE PREFERRED EMBODIMENT

This invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the invention.

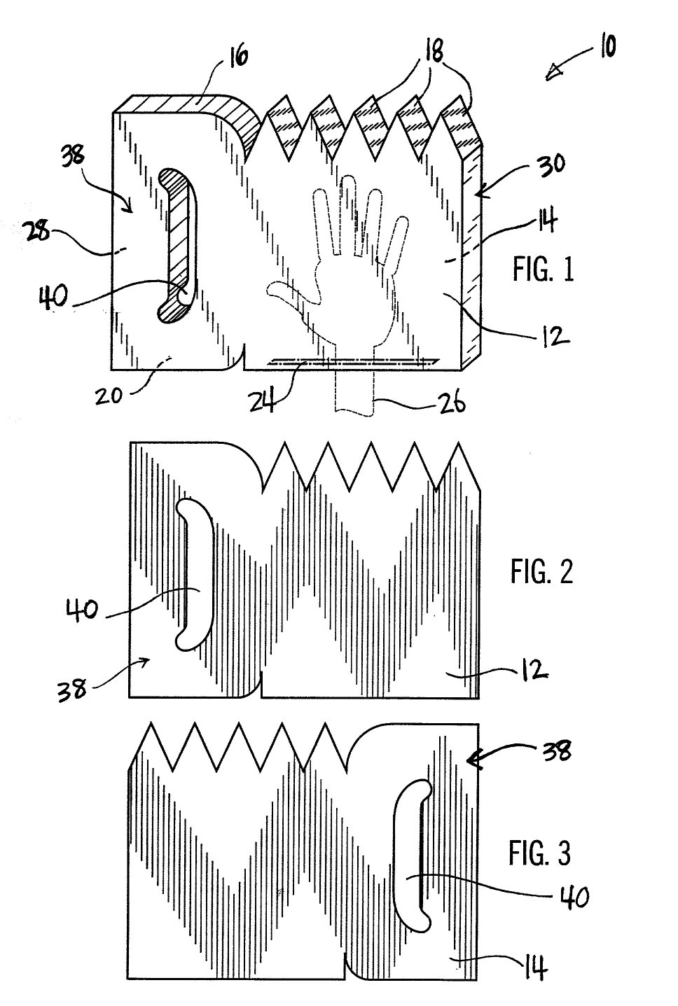

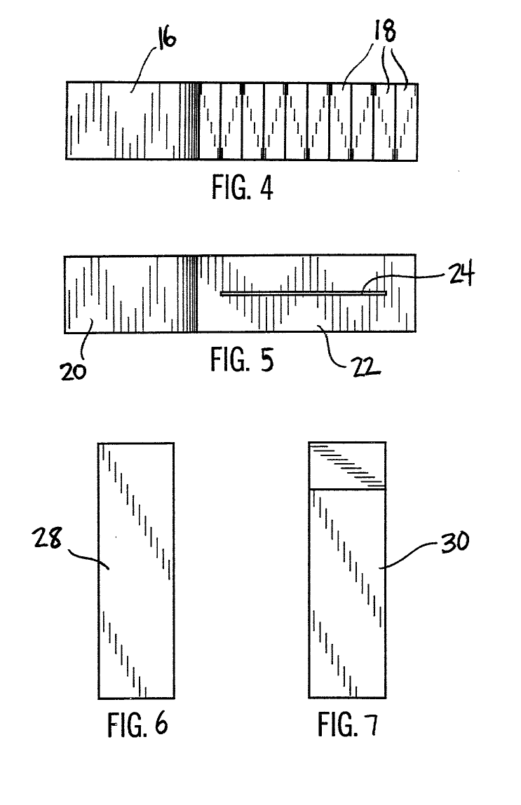

FIGS. 1-8 show cushion 10, which is generally made from a block of foam material such as foam rubber, foam plastic, or other light-weight, soft, pliant material that is easy to carry and that can provide comfortable cushioning when sat upon. Cushion 10 has front face 12, back face 14, left edge 28, and right edge 30. A through hole 40 is formed through front and back faces 12 and 14, respectively. In this embodiment, the through hole 40 forms the inner part of the letter “D.” In FIGS. 4 and 5, the outer contours of the letter “D” are formed by top-D edge 16 and bottom-D edge 20 of the cushion 10. Various types of recesses can be formed on the cushion to form the letter “D” without departing from the scope or spirit of the present invention.

The generally rectangular cushion 10 also has a bottom edge 22 and a top edge 18 that is corrugated in a saw-tooth fashion. These contribute to the shape or outline of a fence. Thus, the fence design together with the, letter “D” design symbolically represents the word “defense,” which can be aptly used by spectators and fans at sporting events.

The cushion 10 can have insignia on any of its surfaces, in particular front face 12 and back face 14. The insignia can be applied directly onto the cushion 10. Some examples of insignia include team logos, team colors, supportive expressions, sponsor information or advertisements, and any other designs appropriate for the cushion's use. Any applicable design can be implemented into the cushion concept presented in this disclosure. The overall design of the cushion 10 along with any insignia applied thereon is intended to communicate a message during use at a sporting event or to create a novelty item or keepsake.

As shown in FIGS. 1 and 5, a slot 24 runs along the bottom face 20 of cushion 10. During use, the user can slip his hand 26 into the pocket 24 to hold up the cushion 10 and wave it, thereby displaying a particular insignia. This is significantly easier than holding the edge of the body to wave the cushion 10. According to an embodiment of the present invention, the pocket 24 can be configured and sized as a container for goods, such as t-shirts or other memorabilia that may be related to the particular sporting event where the cushion may be used. According to yet another embodiment of the present invention, the pocket 24 can be configured and sized to receive a support rod, stick, or post, as shown in the example of FIG. 9. The rod 50 can be made out of metal and formed into a U-shape so that ends 52 can be used to post the cushion 10 (e.g., on the user's lawn).

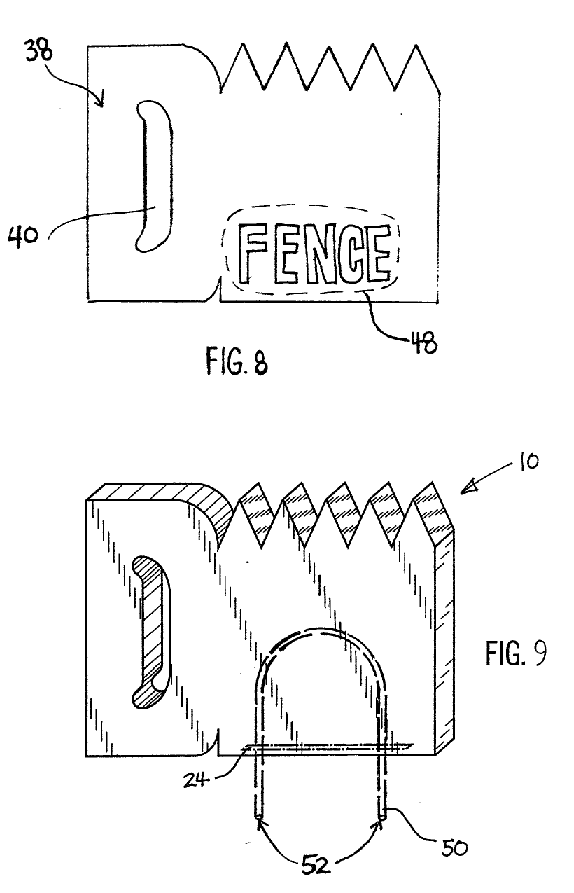

As shown in FIGS. 1-3, the handle 38 serves several purposes. First, the handle 38 facilitates the cushion being carried about by the user. When the cushion 10 is not being held up as a cheering aid, the user can slip his fingers through the hole 40 to grip the cushion 10 at the handle 38. Secondly, the handle 38 serves the purpose of being part of the decorative display, and further with the insignia when the cushion 10 is being waved (or when the cushion 10 is a novelty item/keepsake). For example, FIG. 8 shows how insignia 48 (“FENCE”), combined with the handle 38 and the hole 40 (the letter “D”) represents “Defense.” This combination of words and structural configuration presents an insignia that is clearly visible from afar.

The dimensions of the cushion 10 can range from approximately 9×13″ to 14×19″.

While the present invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

I claim:

1. A combination cheering aid and cushion, comprising:
a body having a front face, a back face, a top edge, and a bottom edge;
a handle;
a slot opening along the bottom face defining a pocket.

2. The combination cheering aid and cushion of claim 1, wherein the handle is defined by a recess in the body.

3. The combination cheering aid and cushion of claim 2, wherein the recess is a hole through the front face and back face.

4. The combination cheering aid and cushion of claim 3, wherein the handle is in shape of the letter “D”.

5. The combination cheering aid and cushion of claim 4, wherein the body includes a notch on the top face and the bottom face to outline the shape of the letter “D”.

6. The combination cheering aid and cushion of claim 4, wherein the body includes a saw-tooth corrugation along the top edge.

7. The combination cheering aid and cushion of claim 6, wherein the pocket is sized to receive a user's hand while the user waves the body during cheering use.

8. The combination cheering aid and cushion of claim 1, wherein the pocket is sized to receive an object, and further comprising the object inserted in the pocket.

9. The combination cheering aid and cushion of claim 8, wherein the object is a souvenir including at least one of a t-shirt or memorabilia.

10. The combination cheering aid and cushion of claim 1, further comprising a support post inserted in the pocket.

11. The combination cheering aid and cushion of claim 10, wherein the support post is generally U-shaped.

12. The combination cheering aid and cushion of claim 1, wherein the body is made of foam plastic.

13. The combination cheering aid and cushion of claim 1, wherein the dimensions of the body are in the range of 8 inches by 11 inches and 15 inches by 20 inches.

14. The combination cheering aid and cushion of claim 1, wherein the body has insignia on the front face.

15. The combination cheering aid and cushion of claim 14, wherein the insignia includes supportive expressions for use at sporting events.

16. The combination cheering aid and cushion of claim 14, wherein the insignia includes a team logo.

17. The combination cheering aid and cushion of claim 14, wherein the insignia includes a team color.

18. The combination cheering aid and cushion of claim 14, wherein the insignia includes sponsor advertisements.

19. The combination cheering aid and cushion of claim 14, wherein the insignia is on the back face.
